(19) United States
(12) Patent Application Publication
(10) Pub. No.: US 2022/0213003 A1
(43) Pub. Date: Jul. 7, 2022

(54) AGRICULTURAL FORMULATIONS AND METHODS FOR MAKING AND USING SAME

(71) Applicants: Loveland Products, Inc., Loveland, CO (US); Tenfold Technologies, LLC, Pilot Point, TX (US)

(72) Inventors: Baozhong Xing, Loveland, CO (US); Allana K. Welsh, Denton, TX (US); Maud A.W. Hinchee, Little Elm, TX (US)

(21) Appl. No.: 17/616,919

(22) PCT Filed: Jun. 5, 2020
(86) PCT No.: PCT/US2020/036431

§ 371 Date: Dec. 6, 2021

Related U.S. Application Data
(60) Provisional application No. 62/858,198, filed on Jun. 6, 2019.

(51) Int. Cl. C05F 11/08

(52) U.S. Cl. CPC C05F 11/08

(57) ABSTRACT

In some embodiments, an agricultural formulation includes living microorganisms and an elevated concentration of a chelating agent. Formulations include one or more populations of live microorganisms, a chelate composition including at least one chelating agent and at least one micronutrient, and optionally one or more macronutrients and/or a biostimulant. Formulations can have a shelf life of at least 2 years.

### CROSS-REFERENCE TO RELATED APPLICATIONS

This application is a U.S. 371 National Stage application of International Patent Application No. PCT/US2020/036431, filed Jun. 5, 2020, which claims the benefit of U.S. Provisional Application No. 62/858,198, filed Jun. 6, 2019, the contents of which are both expressly incorporated herein by reference in their entirety.

### FIELD

The present disclosure relates generally to agricultural formulations including one or more populations of living microorganisms. More particularly, the present disclosure relates to formulations including one or more populations of living microorganisms and an elevated concentration of chelating agent. The present disclosure also relates to agricultural formulations having an extended shelf life.

### BACKGROUND

A range of commercial biofertilizer formulations are available on the market, with different strategies having been employed to try to ensure viability of the microorganisms of the biofertilizer. These strategies include optimization of dry biofertilizer formulations and liquid biofertilizer formulations. With dry biofertilizer formulations, a carrier is used as a vehicle for the microorganisms. The carrier plays a role in maintaining the viability of the microorganisms, thereby affecting the shelf-life of the biofertilizer formulation. To date, most dry biofertilizer formulations have a shelf life of about 6 months or less.

Liquid biofertilizer formulations have demonstrated greater shelf-lives of up to about 2 years. However, process costs associated with the production of a liquid biofertilizer formulation are significantly higher than with a dry formulation. There is a need for inexpensive liquid biofertilizers having a shelf life that extends beyond a single growing season.

Many liquid biofertilizers are immiscible in standard phosphate fertilizers and/or form a precipitate when combined with the standard phosphate fertilizer (e.g., 10-34-0 liquid fertilizer). Most biofertilizers used in larger-scale agriculture are not the primary fertilizer used, and are rather a supplement to, or partial replacement of, a standard fertilizer. If the biofertilizer is not compatible with the standard fertilizer and common practices, they are unlikely to be adopted by farmers. There is a need for biofertilizers that are readily compatible with standard fertilizers and common agricultural practices.

### SUMMARY

The present disclosure provides agricultural formulations comprising living microorganisms and an elevated concentration of a chelating agent. In certain embodiments, the formulations further comprise one or more macronutrients. The microorganisms, when applied to soil, seeds, or plants, can assist plants in accessing nutrients available in the surrounding environment, and when applied in conjunction with a conventional fertilizer, assist in uptake of the provided nutrients. Application of such beneficial microorganisms in a biofertilizer can improve plant nutrient uptake, thereby improving plant growth, vigor, and/or yield.

Certain embodiments provide a composition, the composition comprising: one or more populations of live microorganisms; a chelate composition comprising at least one chelating agent and at least one micronutrient; and one or more macronutrients.

In some embodiments, the composition further comprises water.

In some embodiments, the composition further comprises a biostimulant. The biostimulant may include dead microorganisms, fragments of dead microorganisms, metabolites of microorganisms, microorganism fermentation products, enzymes, biological plant growth regulators, organic acids, chelators, or a combination thereof.

In some embodiments, the one or more populations of live microorganisms promotes plant health, promotes plant growth, promotes plant micronutrient uptake, increases and/or accelerates nitrogen fixation, increases phosphorus availability, or a combination thereof.

In some embodiments, at least one of the one or more populations of live microorganisms is a population of Bacillus amyloliquefaciens.

In some embodiments, the chelating agent is selected from ethylenediaminetetraacetic acid (EDTA), (2-hydroxyethyl)ethylenediaminetriacetic acid (HEDTA), diethylenetriamine pentaacetate (DTPA), ethylenediamine-N,N′-bis(2-hydroxyphenylacetic acid) (EDDHA), nitrilotriacetate (NTA), ethylene glycol tetraacetate (EGTA), rhamnolipid, polyethyleneimine (PEI) , a lignosulfonate, a humic acid, a fluvic acid, an organic acid, a phenol, a polyflavinoid, citrate, ammonia, amines, or a combination thereof.

In some embodiments, the chelating agent is complexed with a micronutrient metal cation selected from the group consisting of zinc, iron, copper, cobalt, manganese, and magnesium,

In some embodiments, the chelate composition is present in an amount from about 30% (wt.) to about 99% (wt.).

In some embodiments, the one or more macronutrients is selected from nitrogen, phosphorous, and potassium.

In some embodiments, a composition described herein comprises: the one or more populations of live organisms in an amount from about 0.01% (wt.) to about 30% (wt.); the chelate composition in an amount from about 30% (wt.) to about 99% (wt.); one or more macronutrients in an amount from about 0.002%/wt. to about 7%wt.; and biostimulant in an amount from about 0%/wt. to about 30%/wt.

Certain embodiments described herein provide a fertilizer additive comprising a composition described here.

Other embodiments described herein provide a fertilizer formulation comprising a composition described herein and a conventional fertilizer. In some embodiments, the conventional fertilizer comprises at least one of ammonia, urea, ammonium nitrate, ammonium sulfate, ammonium thiosulfate, monoammonium phosphate (MAP), diammonium phosphate (DAP), muriate of potash (MOP), sulfate of Potash (SOP); and potassium nitrate (NOP).

In some embodiments, the composition is mixed with the conventional fertilizer in a ratio of about 3:1 to about 1:100. In certain embodiments, the conventional fertilizer in a ratio of about 1:20.

In some embodiments, the composition is splash mixed into the conventional fertilizer.

Certain embodiments provide a seed treatment comprising a composition described herein.

Certain embodiments provide a method, the method comprising applying a composition described herein to soil or a plant. In some embodiments, the composition is applied in-furrow to the soil, applied foliarly to the plant, or sprayed onto the soil and/or plants.

Certain embodiments provide a method, the method comprising applying a fertilizer composition described herein to soil or a plant. In some embodiments, the composition is applied in-furrow to the soil, applied foliarly to the plant, or sprayed onto the soil and/or plants.

### DETAILED DESCRIPTION

The present disclosure generally relates to agricultural formulations comprising living microorganisms and an elevated concentration of a chelating agent. In certain embodiments, the formulations further comprise one or more macronutrients.

Formulations of the present disclosure include one or more populations of living microorganisms. Microorganisms, when applied to soil, seeds, or plants, can assist plants in accessing nutrients available in the surrounding environment, and when applied in conjunction with a conventional fertilizer, assist in uptake of the provided nutrients. Application of such beneficial microorganisms in a biofertilizer can improve plant nutrient uptake, thereby improving plant growth, vigor, and/or yield.

Beneficial microorganisms include, but are not limited to nitrogen fixing soil bacteria, nitrogen fixing cyanobacteria, phosphate solubilizing bacteria, and mycoiThizal fungi.

Nitrogen fixing bacteria include but are not limited to Rhizobium spp., Azospirilum spp., Anabaena spp., Nostoc spp., Azobacter spp., Beijerinckia spp., Clostridium spp.

In certain embodiments, the one or more populations of microorganisms includes phosphate solubilizing bacteria. The phosphate solubilizing bacteria increase bioavailable phosphorous for uptake and use by plants. Phosphate solubilizing bacteria include strains from the genera Pseudomonas, Bacillus, and Rhizobium. In certain embodiments, the one or more populations of microorganisms includes Bacillus amyloliquefaciens, Nostoc spp., Aulosira spp., Anabaena spp., Tolypothrix spp., Bradyrhizobium spp., Rhizobium spp., Sinorhizobium spp., Asorhizobium spp., Penicillium spp., and combinations thereof.

In some embodiments, the Nostoc spp. is Nostoc commune. In some embodiments, the Aulosira spp. is Aulosira bohemensis. In some embodiments, the Anabaena spp. is Anabaena cylindrica. In some embodiments, the Tolypothrix spp. is Tolypothrix distorta. In some embodiments, the Penicillium spp. is P. bilaeae and/or P. gaestrivorus. In some embodiments, the Rhizobium spp. is R. leguminosarum. In some embodiments, the Sinorhizobium spp. is S. meliloti. In some embodiments, the Bradyrhizobium spp. is B. japonicum.

Without wishing to be bound by any particular theory, it is thought that B. amyloliquefaciens promotes plant growth at least in part by solubilizing phosphate.

In certain embodiments, the one or more populations of microorganisms are capable of promoting plant health, promoting plant growth, promoting plant micronutrient uptake, increasing phosphorous accessibility, fixing nitrogen, or a combination thereof.

In certain embodiments, at least some of the microorganisms of the one or more populations of microorganisms are dormant and are present in the formulation as endospores.

In certain embodiments, formulations of the present disclosure include about 10² cfu/ml to about 10¹⁰ cfu/ml of total live microorganisms. In some embodiments, the formulation includes about 10⁵ cfu/ml of total live microorganisms. In some embodiments, the formulation includes at least about 10³ cfu/ml of total live microorganisms. In certain embodiments, live microorganisms are present in an aqueous medium and are mixed into the formulation. In some embodiments, the aqueous medium including the live microorganisms mixed into the formulation makes up about 0.01% to about 30% (wt.) of the formulation. The amount of aqueous medium including the live microorganisms to be included in the formulation will depend at least in part on the concentration of live microorganisms present in the aqueous medium. Where the aqueous medium has a higher concentration of live microorganisms present therein, less of the aqueous medium may need to be included (as % wt.). Where the aqueous medium has a lower concentration of live microorganism present therein, more may need to be included (as % wt.). The amount of aqueous medium included in a formulation can be adjusted to provide the desired number of live microorganisms in the formulation (e.g., in cfu/ml).

In addition to the one or more populations of living microorganisms, formulations of the present disclosure include a chelate composition. The chelate composition includes at least one chelating agent or a mixture of chelating agents and one or more micronutrients.

Chelating agents can be used in agricultural formulations such as fertilizers. Used to chelate micronutrients such as zinc, iron, copper, cobalt, manganese, nickel, calcium, and magnesium, chelating agents surround the inorganic micronutrients, forming a weak bond. This effectively gives the nutrient an organic coating, aiding in the uptake of the nutrient by a plant. In some embodiments, the chelating agent can be one or more of ethylenediaminetetraacetic acid (EDTA), (2-Hydroxyethyl)ethylenediaminetriacetic acid (HEDTA), diethylenetriamine pentaacetate (DTPA), ethylenediamine-N,N′-bis(2-hydroxyphenylacetic acid) (EDDHA), nitrilotriacetate (NTA), ethylene glycol tetraacetate (EGTA), rhamnolipid, polyethyleneimine (PEI), a lignosulfonate, a humic acid, a fluvic acid, an organic acid such as citric acid, boric acid, or ascorbic acid, a phenol, organic amines, ammonia, and a polyflavinoid.

In certain embodiments, one or more chelating agents are included in the chelate composition. The chelate composition can be, for example, a solution that includes the one or more chelating agents. The one or more chelating agents form a chelate with the micronutrients present in the chelate composition. In some embodiments, the one or more micronutrients is selected from zinc, iron, copper, cobalt, manganese, nickel, calcium, and magnesium.

In certain embodiments, the one or more chelating agents include EDTA, HEDTA, or both EDTA and HEDTA.

In certain embodiments, at least some microorganisms of the one or more populations of living microorganisms can use at least one of the one or more chelating agents as a carbon source.

In certain embodiments, formulations of the present disclosure reduce or prevent formation of a precipitate when mixed with a standard liquid fertilizer (e.g., 10-34-0 liquid fertilizer). When other biofertilizers are mixed with a standard liquid fertilizer, they may form a precipitate or a thin layer that can prevent effective use of the biofertilizer/standard fertilizer mixture. For example, the precipitate may affect equipment, such as fertilizer sprayers. When a thin layer of precipitation formed on the surface of crops it may decrease the efficacy of biofertilizer and the micronutrients. By preventing formation of a precipitate, formulations of the present disclosure improve compatibility of the biofertilizer with standard liquid fertilizers, such as phosphate liquid fertilizers.

In certain embodiments, formulations of the present disclosure are mixable with a standard liquid fertilizer (e.g., 10-34-0 liquid fertilizer), forming a single phase. In some embodiments, the mixture of the formulation and the standard fertilizer is homogenous or nearly homogenous. When mixing biofertilizers with standard fertilizers, the two often separate into distinct phases. This phase separation requires mixing, which may be extensive, adding an additional step to the fertilizing process and potentially requiring additional equipment. Even after thorough mixing, the biofertilizer and the standard liquid fertilizer may quickly separate again, preventing successful mixing. In some embodiments, some minor separation may occur when mixing a formulation of the present disclosure with a standard liquid fertilizer, although the two can be returned to a single phase with gentle mixing. Thus, with formulations of the present disclosure forming a single phase when mixed with a standard fertilizer, farmers can simply add the formulations to the standard fertilizer by splash mixing (i.e., adding the formulation to the standard fertilizer), with no or minimal additional mixing. With the formulations having improved compatibility with standard fertilizers, end users can easily include the formulations in their normal fertilizing regimen.

In certain embodiments, chelate compositions include micronutrients in an amount of about 0.001% to about 75% (total wt.). In some embodiments, micronutrients of the chelate composition are about 50% to 100% chelated. The chelate composition can include a molar ratio of chelating agent sufficient to achieve the desired chelation of micronutrients. Tn some embodiments, the chelate composition includes a molar ratio of micronutrient to chelating agent of about 2:1, about 1:1, about 1:2, or about 1:3.

In certain embodiments, chelate compositions include one or more macronutrients. Macronutrients include, but are not limited to, nitrogen, phosphorus, and potassium.

In some embodiments, the chelate composition makes up about 5% to about 99% (wt.) of the total product.

In some embodiments, a chelate composition includes about 2.5% to about 15% zinc and about 2% to about 15% nitrogen. In an embodiment, the chelate composition includes Zn-EDTA, with 9% Zn and 4% N (i.e., 4-0-0). In another embodiment, the chelate composition includes Zn-EDTA with 10% Zn. In some embodiments, the chelate composition comprises Pro Zinc 10, available from Loveland Products of Loveland, Colorado. Additionally or alternatively, the chelate composition comprises Pro Zinc 10+, available from Loveland Products of Loveland, Colorado. Although these representative examples of chelate compositions are describes, other chelate compositions can be used in the formulations described herein.

In certain embodiments, formulations of the present disclosure include up to about 99% (wt.) chelate composition. In some embodiments, formulations include about 20% to about 85% (wt.) chelate composition. In some embodiments, formulations include about 50% to about 85% (wt.) chelate composition. In some embodiments, formulations include about 70% to about 80% (wt.) chelate composition. In some embodiments, formulations include about 75% (wt.) chelate composition.

In certain embodiments, formulations of the present disclosure include one or more macronutrients. In some embodiments, macronutrients in addition to that or those macronutrients included in the chelate composition are included in the formulation. Macronutrients include, but are limited to, nitrogen, phosphorous, and potassium.

In certain embodiments, formulations of the present disclosure include a biostimulant. In some embodiments, a biostimulant includes dead microorganisms, fragments of dead microorganisms, metabolites of microorganisms, microorganism fermentation products, enzymes, biological plant growth regulators, organic acids, chelators, or a combination thereof. In some embodiments, the biostimulant increases nutrient availability when applied in conjunction with a conventional fertilizer, improves plant performance, improves nutrient availability and uptake, enhances root growth and function, or a combination thereof.

In some embodiments, the biostimulant includes a product resulting from a fermentation of manure, algae (e.g., seaweed), leonardite or other low-rank coal, or a combination thereof. In some embodiments, the biostimulant is a soil amendment described in U.S. application Ser. No. 13/844,544, which is hereby incorporated by reference in its entirety.

In certain embodiments, the biostimulant is in an aqueous solution. In certain embodiments, formulations of the present disclosure include up to about 30% (wt.) biostimulant. In some embodiments, formulations include about 10% to about 30% (wt.) biostimulant. In some embodiments, formulations include about 20% to about 30% (wt.) biostimulant. In some embodiments, formulations include about 20% (wt.) biostimulant.

In certain embodiments, formulations of the present disclosure include water. In some embodiments, formulations include about 0.1% to about 10% (wt.) water. In some embodiments, formulations include about 0.1% to about 2% (wt.) water. The chelating agent(s), one or more populations of live microorganisms, urea, and biostimulant may be included in the formulation as aqueous solutions. Therefore, in certain embodiments, the amount of water included in the formulation refers to added water only, and does not take into account the water content of the aqueous solutions mixed into the formulation.

In certain embodiments, the cost to produce a formulation of the present disclosure in minimal. In some embodiments, the cost to produce a formulation of the present disclosure is lower than that to produce liquid biofertilizers known in the art.

### Use and Methods of Making

The agricultural formulation described herein, when applied to soil, seeds, or plants, improve nutrient availability to plants and/or improve uptake of nutrients provided by a conventional fertilizer. The agricultural formulations described herein improve plant nutrient uptake, improving plant health, growth, vigor, and/or yield. In certain embodiments, the agricultural formulations have an extended shelf life. In some embodiments, the formulations have a shelf life that extends beyond a single growing season. In some embodiments, the formulations have a shelf life of at least about two years. Without wishing to be bound by any particular theory, shelf life may be extended by the live microorganisms separating into a distinct phase during extended storage. Being separate from the remaining components of the formulation may improve survival of the live microorganisms. However, the separated layer of live microorganisms can be mixed back to the formulation with reasonable agitation/mixing that will not affect the efficacy of the product.

In certain embodiments, agricultural formulations described herein are applied to soil, applied directly to plants, or applied to both soil and plants. Formulations can be used in in-furrow applications, foliar applications, or both. In some embodiments, the formulation is applied on its own. When applied on its own, in some embodiments, the formulation is applied before or after application of a conventional fertilizer. When applied before or after application of a conventional fertilizer, the formulation is applied sufficiently close in time to the conventional fertilizer so that the formulation may have its desired effect of improving uptake of nutrients provided by the conventional fertilizer. In some embodiments, the formulation is applied in conjunction with a conventional fertilizer. The formulation can either be mixed with a conventional fertilizer or applied simultaneously with a conventional fertilizer.

In some embodiments, the agricultural formulations described herein are mixed with a conventional fertilizer at a ratio of about 3:1 to about 1:100 formulation to conventional fertilizer. In some embodiments, formulations are mixed with a conventional fertilizer in a ratio of about 1:20 formulation to conventional fertilizer.

In certain embodiments, the conventional fertilizer is a starter fertilizer. In some embodiments, the conventional fertilizer includes at least one of ammonia, urea, ammonium nitrate, ammonium sulfate, ammonium thiosulfate, monoammonium phosphate (MAP), diammonium phosphate (DAP), muriate of potash (MOP), sulfate of Potash (SOP), potassium nitrate (NOP). In some embodiments, the starter fertilizer is a 10-34-0 starter fertilizer.

In certain embodiments, the agricultural formulations described herein are applied to soil or plants in an amount of about 1 to about 10 quarts per acre. In some embodiments, the formulations are applied in an amount of about 3 quarts per acre.

In certain embodiments, agricultural formulations described herein are applied to seed as a seed treatment. In some embodiments, formulations to be used as a seed treatment do not include a biostimulant

The formulations described herein can be formed by mixing the components in a tank (i.e., tank mix). Following mixing, formulations can be bottled or otherwise packaged (e.g., in drums), applied to a field or crop, or mixed with a conventional fertilizer. When bottled or otherwise packaged, the end user can mix the formulation with a conventional fertilizer prior to application. The formulation can be mixed with the conventional fertilizer by tank mixing, including splash mixing with minimal further mixing, or can be blended into the conventional fertilizer.

The present invention is more particularly described in the following examples that are intended as illustrations only, since numerous modifications and variations within the scope of the present invention will be apparent to those of skill in the art. Unless otherwise noted, all parts and percentages in the following examples are on a percent weight basis.

### EXAMPLES

### Formulations for Soil and Crop Applications

Various agricultural formulations of the present disclosure were prepared by combining one or more populations of live microorganisms, a chelating agent, urea, water, and biostimulant. The following are examples of formulations that were prepared, and that may be used in soil or crop applications. The formulations can be used according to the methods described herein. Where a seed treatment including a biostimulant is desired, the following formulations may also be used as a seed treatment.

### Formulation 1.

| Fe-HEDTA solution | | 75% |
|---|---|---|
| B. amyloliquefaciens | | 0.5% |
| Urea | | 4.50% |
| Seaweed-derived biostimulant | | 19% |
| Water | | 1% |
| | Total | 100% |

### Formulation 2.

| Zn-EDTA solution | | 75% |
|---|---|---|
| B. amyloliquefaciens | | 0.5% |
| Urea | | 4.50% |
| Leonardite-derived biostimulant | | 20% |
| Water | | % |
| | Total | 100% |

### Formulation 3.

| Cu-EDTA solution | | 70% |
|---|---|---|
| B. amyloliquefaciens | | 0.5% |
| Urea | | 4.50% |
| Seaweed-derived biostimulant | | 15% |
| Water | | 10% |
| | Total | 100% |

### Formulation 4.

| Zn-EDTA solution | | 70% |
|---|---|---|
| B. amyloliquefaciens | | 0.3% |
| Urea | | 4.70% |
| Leonardite-derived biostimulant | | 24% |
| Water | | 1% |
| | Total | 100% |

### Formulation 5.

| Mn-EDTA solution | | 50% |
|---|---|---|
| B. amyloliquefaciens | | 0.5% |
| Urea | | 4.50% |
| Seaweed-derived biostimulant | | 20% |
| Water | | 25% |
| | Total | 100% |

### Formulation 6.

| Zn-EDTA solution | | 80% |
|---|---|---|
| B. amyloliquefaciens | | 0.5% |
| Urea | | 4.50% |
| Manure-derived biostimulant | | 14% |
| Water | | 1% |
| | Total | 100% |

### Formulations for Seed Treatment.

Various agricultural formulations of the present disclosure for use as a treatment can be prepared by combining one or more populations of live microorganisms, a chelating agent, urea, and water. The following formulation is an example of a formulation that was prepared, and that may be used as a seed treatment. The formulations can be used according to the methods described herein.

Formulation 7.

| | | |
|---|---|---|
| Zn-EDTA | (Dry) | 62% |
| Mn-EDTA | (Dry) | 3.7% |

| | | |
|---|---|---|
| Urea | | 1.5% |
| Water | | 13.3% |
| Biostimulant mixture | | 20% |
| B. amyloliquefaciens | | 0.5% |
| | Total | 100% |

### Formulation 8.

| | | |
|---|---|---|
| Zn-EDTA | (Dry) | 34% |
| Mn-EDTA | (Dry) | 3.7% |

| | | |
|---|---|---|
| Urea | | 1.5% |
| Water | | 40.3% |
| Biostimulant mixture | | 20% |
| B. amyloliquefaciens | | 0.5% |
| | Total | 100% |

### Live Microorganism Survival: Part A

Experiments were conducted to determine the survival of B. amyloliquefaciens when included in a formulation similar to those of Formulations 1-6.

A first sample of the formulation was stored at room temperature (approximately 25° C.), while a second sample of the formulation was stored at 40° C. in an accelerated aging shelf life test. At Day 7, Day 14, Day 28, and Day 62 time points, both the room temperature and accelerated shelf-life samples were analyzed. In the accelerated aging shelf life test, 60 days at 40° C. approximates storage at room temperature for 2 years.

Analysis of the solutions included quantifying the total bacteria in un-heated product and observing the physical stability of the formulations. The only bacteria present in the solution at detectable levels was the B. amyloliquefaciens that was included in the formulation. A subsample of each product was passed through a series of 10-fold dilutions and 0.1 ml was plated on standard microbial nutrient media. The microbial nutrient media was ¼ strength TSA (Tryptic soy agar) media. The ¼TSA plates were incubated at 30° C. for up to seven days. After incubation, total colony forming units (CFUs) were counted.

At Day 0, B. amyloliquefaciens was present at 4.80×10⁶ CFU/mL. B. amyloliquefaciens survival results are presented in Table 1.

TABLE 1
B. amyloliquefaciens survival in a formulation of the
present disclosure (CFU/mL)

| | storage at 25° C. | storage at 40° C. |
|---|---|---|
| Day 0 | 4.80 × 10⁶ | |
| Day 7 | 4.85 × 10⁶ | 8.18 × 10⁷ |
| Day 14 | 4.40 × 10⁶ | 2.88 × 10⁶ |
| Day 28 | 5.25 × 10⁶ | 4.65 × 10⁶ |
| Day 62 | 4.30 × 10⁶ | 4.35 × 10⁵ |

B. amyloliquefaciens was very stable at room temperature (i.e., 25° C.) as demonstrated by the formulation having the same bacterial abundance of ˜5×10⁶ CFU/mL on Days 0, 7, 14, 28, and 62. In the accelerated aging samples (incubation at 40° C.), the bacterial abundance data demonstrated some fluctuations in CFU, and after 62 days there was a 10-fold loss in viable cells (˜4×10⁵ CFU/mL) compared to the Day 0 abundances. The accelerated shelf-life test (40° C. for 62 days) would be roughly equivalent to two years at room temperature. Even after 62 days in an accelerated shelf life test, the abundance of B. amyloliquefaciens CFU/mL remained significant.

Similar experiments to those described above were conducted to determine the survival of B. amyloliquefaciens when included in a zinc ammonium acetate-based formulation, in contrast to a chelate composition-based formulation described herein. A sample of the zinc ammonium acetate-based formulation was stored at room temperature on a darkened shelf. The sample was tested 3, 4, 5, 7, and 9 months following production.

The abundance of bacteria in un-heated product and pasteurized product should have been about the same. Any differences between the unheated and pasteurized product likely relate to instability of the B. amyloliquefaciens heat-resistant spores. Analysis of the zinc ammonium acetate-based formulation included quantifying total bacteria in un-heated or pasteurized product. The formulation was analyzed for microbial content and then pasteurized (heated to 80° C. for 15 minutes) to remove non-spore forming bacteria, after which the sample was analyzed again.

The only bacteria present in the solution at detectable levels was the B. amyloliquefaciens that was included in the formulation. A subsample of each product was passed through a series of 10-fold dilutions and 0.1 ml was plated on standard microbial nutrient media. The microbial nutrient media was ¼ strength TSA (Tryptic soy agar) media. The ¼ TSA plates were incubated at 30° C. for up to seven days. After incubation, total colony forming units (CFUs) were counted.

An initial concentration of B. amyloliquefaciens of 6.25 x 10⁶ CFU/mL was estimated for the formulation. The concentration of colony forming units per milliliter (CFU/mL) of bacteria in the sample (before and after pasteurization) after 3, 4, 5, 7, and 9 months of storage at room temperature on a darkened shelf is presented om Table 2.

TABLE 2
B. amyloliquefaciens survival in a zinc ammonium
acetate-based formulation (CFU/mL)

| | Month 3 | Month 4 | Month 5 | Month 7 | Month 9 |
|---|---|---|---|---|---|
| Un-heated | 5.45 × 10⁵ | 5.80 × 10⁵ | 5.05 × 10⁵ | 7.10 × 10⁵ | 4.35 × 10⁵ |
| Pasteurized | NT | 5.10 × 10⁵ | 4.20 × 10⁵ | 4.70 × 10⁵ | 2.90 × 10⁵ |

In contrast to the formulations of the instant disclosure, after only three months, the actual concentration of B. amyloliquefaciens in the zinc ammonium acetate-based formulation was 5.45×105 CFU/mL, about 10× lower than expected due to negative impacts of the formulation on bacterial survivorship.

### Live Microorganism Survival: Part B

Experiments were conducted to determine the survival of B. amyloliquefaciens when included in Formulation 7.

B. amyloliquefaciens was added to a solution of Formulation 7 at a ratio of 1:4 (20% B. amyloliquefaciens). The resulting solution was mixed, left to sit for 1 hour, and then diluted in 9 ml 0.1 HMP and plated onto ¼ TSA agar. Plates were incubated at 30° C. for 4 days, then colony-forming units per mL (CFU/mL) product were counted. After plating on Day 0 the resulting solution was split into two sterile, 50 mL conical tubes. One conical tube was stored at room temperature and the other conical tube was stored at 40° C. in an accelerated shelf-life test. After 7 days, both tubes were removed from storage and plated again for total bacteria

Bacterial abundance was similar at Day 7 for both storage conditions (room temperature and 40° C.), and was similar as that determined on Day 0. Bacterial abundance was similarly maintained at Day 28 for both storage conditions. The accelerated shelf-life test (40° C. for 28 days) would be roughly equivalent to one year at room temperature. Even after 28 days in an accelerated shelf life test, the abundance of B. amyloliquefaciens CFU/mL remained significant.

1. A composition comprising:
i. one or more populations of live microorganisms; and
ii. a chelate composition comprising at least one chelating agent and at least one micronutrient, wherein the chelate composition is present in an amount from about 20% (wt.) to about 99% (wt.).

2. The composition of claim 1, wherein the composition further comprises one or more macronutrients.

3. The composition of claim 1, wherein the composition further comprises water.

4. The composition of claim 1, wherein the composition further comprises a biostimulant.

5. The composition of claim 4, wherein the biostimulant comprises dead microorganisms, fragments of dead microorganisms, metabolites of microorganisms, microorganism fermentation products, enzymes, biological plant growth regulators, organic acids, chelators, or a combination thereof.

6. The composition of claim 1, wherein at least one of the one or more populations of live microorganisms promotes plant health, promotes plant growth, promotes plant micronutrient uptake, increases and/or accelerates nitrogen fixation, increases phosphorus availability, or a combination thereof.

7. The composition of claim 1, wherein at least one of the one or more populations of live microorganisms is a population of Bacillus amyloliquefaciens.

8. The composition of claim 1, wherein the chelating agent is selected from ethylenediaminetetraacetic acid (EDTA), (2-Hydroxyethyl)ethylenediaminetriacetic acid (HEDTA), diethylenetriamine pentaacetate (DTPA), ethylenediamine-N,N′-bis(2-hydroxyphenylacetic acid) (EDDHA), nitrilotriacetate (NTA), ethylene glycol tetraacetate (EGTA), rhamnolipid, polyethyleneimine (PEI), a lignosulfonate, a humic acid, a fluvic acid, an organic acid, a phenol, a polyflavinoid, citrate, ammonia, amines, or a combination thereof.

9. The composition of claim 1, wherein the chelating agent is complexed with a micronutrient metal cation selected from the group consisting of zinc, iron, copper, cobalt, manganese, and magnesium.

10. (canceled)

11. The composition of claim 1, wherein the chelate composition is present in an amount from about 50% (wt.) to about 85% (wt.).

12. The composition of claim 1, wherein the one or more macronutrients is selected from nitrogen, phosphorous, and potassium.

13. The composition of claim 4, wherein the composition comprises:
i. the one or more populations of live organisms in an amount from about 0.01% (wt.) to about 30% (wt.);
ii. the chelate composition in an amount from about 50% (wt.) to about 85% (wt.);
iii. one or more macronutrients in an amount from about 0% wt. to about 7% wt.;
iv. biostimulant in an amount from about 0% wt. to about 30% wt.

14. (canceled)

15. A fertilizer formulation comprising the composition of claim 1 and a conventional fertilizer.

16. The fertilizer formulation of claim 15, wherein the conventional fertilizer comprises at least one of ammonia, urea, ammonium nitrate, ammonium sulfate, ammonium thiosulfate, monoammonium phosphate (MAP), diammonium phosphate (DAP), muriate of potash (MOP), sulfate of Potash (SOP), and potassium nitrate (NOP).

17. The fertilizer formulation of claim 15, wherein the composition is mixed with the conventional fertilizer in a ratio of about 3:1 to about 1:100.

18. The fertilizer formulation of claim 15, wherein the composition is mixed with the conventional fertilizer in a ratio of about 1:20.

19. The fertilizer formulation of claim 15, wherein the composition is splash mixed into the conventional fertilizer.

20. (canceled)

21. A method comprising applying the composition of claim 1, to soil or a plant

22. The method of claim 21, wherein the composition is applied in-furrow to the soil, applied foliarly to the plant, or sprayed onto the soil and/or plants.

23. (canceled)

24. (canceled)
